(19) United States
(12) Patent Application Publication
(10) Pub. No.: US 2023/0255249 A1
(43) Pub. Date: Aug. 17, 2023

(54) COMPOSITION AND METHOD FOR MANUFACTURING CLEAR BEVERAGES COMPRISING NANOEMULSIONS WITH QUILLAJA SAPONINS

(71) Applicant: Givaudan S.A., Vernier (CH)

(72) Inventors: Matthias SCHULTZ, Uster (CH); Vivianne MONNIER, Schwerzenbach (CH)

(21) Appl. No.: 18/141,109

(22) Filed: Apr. 28, 2023

Related U.S. Application Data
(63) Continuation of application No. 14/383,645, filed on Sep. 8, 2014, now Pat. No. 11,666,079.

(51) Int. Cl. A23L 29/10; A23L 2/385; A23L 2/52; A23L 2/39; A23L 2/56; A23L 29/25

(52) U.S. Cl. CPC A23L 29/10; A23L 2/385; A23L 2/52; A23L 2/39; A23L 2/56; A23L 29/25; A23V 2002/00

(57) ABSTRACT

A method of making a clear beverage concentrate, which comprises a nanoemulsion of a liquid flavour oil in an aqueous phase, comprising the emulsification of the flavour oil into water in the presence of an emulsifier, which emulsifier consists of at least 5% by weight quillaja saponins, optionally containing at least one other emulsifier, characterised in that, prior to emulsification, the pH of the aqueous phase is adjusted to 4.0 maximum.

The method allows the preparation of beverages that not only are crystal-clear, but which also have substantially more of the full flavour of the original flavour oil.

This disclosure relates to clear beverages and to methods of preparing them.

Clear beverages, particularly those with fruit flavours, require that the flavour be in the form of a nanoemulsion, that is, an emulsion of such small particle size that it gives rise to no discernible turbidity. The particle size of such an emulsion is smaller than the wavelength of visible light, that is, having a maximum diameter of about 150 nm, ideally less than 100 nm.

Emulsifiers are naturally required to make such emulsions, and, as the products are consumables, they must comply with Government regulations concerning such products. Thus, the desire is to use natural emulsifiers. Some traditional emulsifiers of this kind have included gum arabic gum ghatti, gum tragacanth, fenugreek gum, mesquite gum, and sugar beet pectin. These permit the attainment of a minimum particle size of about 200 nm. Thus, a beverage prepared using an emulsion based on gum will have a turbidity of about 200-400 NTU (i.e., Nephelometric Turbidity Unit, a unit of turbidity well-known to and widely used by the art and measured, for example, by a Hach 2100N turbidimeter (ex Hach Company), using the instrument as per the instructions). At this level, some turbidity is still noticeable, and the “crystal-clear” desideratum is not achieved or achievable by this method.

More recently, it has been found and disclosed, for example, in Japanese published application 2010-142205, that certain quillaja extracts could help provide an emulsifier that could result in nanoemulsions and clear beverages. Quillaja extract is an extract obtained from a number of trees of the Quillaja species (family Quillajaceae) native to the Americas. One such tree is Quillaja saponaria Molina, a native of Chile. The extracts are commercially available and are rich sources of saponins (a typical extract will contain about 14% saponins by weight). These extracts are known to be natural foaming agents in a number of applications, including foods and beverages (see, for example, San Martin and Briones in J. Sci. Food Agric 80:2063-2068 (2000)). They are frequently sold in admixture with other, cheaper saponin sources, such as Yucca schidigera and Saponaria officinalis. Quillaja saponins are also commercially available as dried extracts, i.e. a water soluble solid powder with saponin contents of 50% or more.

There has understandingly arisen considerable interest in the quillaja saponins as emulsifiers, in conjunction with other materials. For example, Japanese Publication 2010-142205 mentioned hereinabove describes the use of quillaja extract with a polyoxyethylene sorbitan fatty acid ester. Other examples are PCT published application WO 2011/089249, which describes the use of quillaja saponins, plus a substantial proportion of lechitin, as an emulsifier for clear beverages, and EP 2 359 702, which describes the use of quillaja saponins in combination with polymeric emulsifiers for the emulsification of solid, sparingly water-soluble polyphenols, flavonoids and diterpenoid glucosides.

It has now surprisingly been found that it is possible more effectively to provide a crystal-clear beverage flavoured with a liquid flavour oil, without the need for additional emulsifiers. This disclosure therefore provides a method of making a clear beverage concentrate, which comprises a nanoemulsion of a liquid flavour oil in an aqueous phase, comprising the emulsification of the flavour oil into water in the presence of an emulsifier, which emulsifier consists of at least 5% by weight quillaja saponins, optionally containing at least one other emulsifier, characterised in that, prior to emulsification, the pH of the aqueous phase is adjusted to 4.0 maximum.

The use of this method allows the maintenance of full authenticity of the flavour profile. This is because the method can be used with the original flavour, as opposed to the “washed” flavour commonly used in the art. By “washed flavour” is meant a flavour from which most or even all of the water-insoluble matter (such as monoterpenes) has been removed. While such a “wash” retains the basic flavour, it is lacking in many of the other attributes of the original, such as the “peely”, body, full, round flavour notes of the original. The flavour concentrates of this disclosure retain all of these, and thus provide a more authentic flavour.

The emulsifier consists of at least 5% by weight quillaja saponins. These are commercially available as extracts, for example, the Q-Naturale™ range of products from National Starch, such extracts containing typically 14% by weight saponins. Although it is possible to isolate the quillaja saponins, this is expensive, and in practice it is more usual to use the extract itself, the quantity of extract used being selected to provide the desired proportion of quillaja saponins.

In particular embodiments, the emulsifier consists of 25, 50, 75 and 100% quillaja saponins.

In those cases where other emulsifiers are used, these may be present to the extent of 95% by weight maximum of the total emulsifier. However, as explained above, they may be selected from those emulsifiers known to and used by the art. Non-limiting examples of these include polysorbates, sucrose esters and polyglycerol esters of fatty acids and lecithin. More than one such non-quillaja emulsifier may be used.

The proportion of quillaja saponins (and therefore extract) necessary will vary from application to application, and a skilled person can readily determine an appropriate amount with only simple experimentation. As a general guide, the weight ratio of quillaja saponins to flavour base is of the order of from 0.1-3.0. Although the addition of saponins outside this ratio often has no effect (for example, above 3, the bitter taste of saponins may become noticeable), there might well be particular systems and uses in which ratios outside this range might be useful, and, although the best results are generally obtained with ratios inside the range, they should not be considered absolute limits.

The pH adjustment, which is carried out prior to emulsification, may be achieved by the addition of acid. The acid used may be any food-approved acid, that is, any acid whose use in food and beverages is officially approved. Thus, there can be used not only the usual organic acids, such as citric, malic, acetic and lactic acids, but also such inorganic acids as phosphoric, as used in some cola beverages.

In a typical non-limiting example, the addition of a flavour concentrate according to this disclosure containing 5% by weight of quillaja extract, which extract contains 14% saponins (i.e., 0.7% saponins in the concentrate) with 3% of an orange flavour base to a beverage base adjusted to the appropriate pH (typically water, sucrose or other sweeteners, citric acid and preservatives, sometimes vitamins and other ingredients) will give a clear orange beverage that has a turbidity of less than 10 NTU, i.e., is transparent. Increasing the quillaja extract to 7.5% improves the NTU value only slightly, and in a way that is barely perceptible to the naked eye.

In order to produce a concentrate, it is necessary to subject a blend of a flavour material, water and quillaja extract to high shear blending, such that the desired nanoemulsion particle size is achieved. This is achieved by high pressure homogenisation. This is a technique well known to and frequently used by the art, and the equipment is readily available. In a particular embodiment, the blend of flavour material, water and extract are first subjected to a high shear pre-homogenisation step, and then to sufficient passes on a high pressure homogeniser to achieve the desired result. The pre-homogenisation may typically be carried out using a rotor-stator mixer or a Waring blender. The resulting concentrate has typically from 1-10%, particularly from 2-5%, by weight of flavour material.

It is not possible to produce a nanoemulsion of the desired particle size in a single homogenisation step on standard emulsification equipment, and it is always necessary to carry out the homogenisation several times, or, in the terminology of the art, to make more than one “pass”. For commercialisation purposes, the fewer passes, the better, and large numbers of passes are completely unacceptable. It has been found that some modifications to the process hereinabove described can reduce the number of passes significantly. In some cases, only three passes are necessary to produce a clear nanoemulsion.

In a first modification, at least one monosaccharide or disaccharide sugar may be added to the concentrate. Typical examples include glucose, fructose and sucrose. Sucrose is known from WO 2008/039564 to be useful in combination with sucrose monoesters, but it is surprising that such sugars used alone should have any effect on quillaja extracts. Addition of such sugars (which can be a single sugar or a mixture of two or more such sugars) enables the attainment of a desired nanoemulsion size with a reduced number of passes. The sugars are typically added at a concentration of from 10-50 wt % of the nanoemulsion.

In a second modification, certain solvents may be added to the concentrate. These are selected from propylene glycol (PG) and glycerol. These are well-known beverage solvents, but again it is surprising that their use can have such an effect in the reduction of the number of passes. They may be used typically at a concentration of from 10-95% of the nanoemulsion.

In a particular embodiment, a combination of at least two of PG, glycerol and sucrose produces particularly beneficial effects. It is possible to use PG-sucrose, glycerol-sucrose, PG-glycerol and all three together. A typical example is PG-glycerol at 10%-25%. Further particular examples are PG-glycerol-sucrose at 40-24-27 and 10-25-35.

In a third modification, standard homogenisation equipment with typical pressures up to 50 MPa is be replaced by homogenisation equipment which enables the application of higher pressures (in excess of 100 MPa and up to several hundred MPa). Such equipment is well known, but is not generally used in the beverage flavour industry because the high pressures have not been regarded as necessary or useful—indeed in some circumstances they may be disadvantageous (they can damage gum arabic or modified starch). Examples of such equipment include the Microfluidizer™ (Microfluidics Corp.) and the EmulsiFlex™ (Avestin).

There is thus provided a flavoured clear beverage concentrate, preparable by a method as hereinabove described.

A clear beverage is prepared by blending the concentrate thus prepared with a clear beverage base, i.e., a composition containing any of the standard ingredients known to the art in art-recognised proportions, other than the concentrate. Typically, the flavour concentration in the consumable product will be in the range of from 0.0005-0.05%, particularly from 0.001-0.02%, by weight of the consumable product. The final product is a completely transparent consumable product with a full flavour.

In a further embodiment, the concentrate hereinabove described may be converted to solid form. In this form, it is storage-stable, and can be used to produce a clear consumable product, simply by dissolving it in water or in a consumer product base containing any of the standard ingredients known to the art in art-recognised proportions. The process may be performed by adding to the concentrate an aqueous solution of a carrier and then spray-drying the resultant mixture. The result is a non-sticky powder, which can be used in this form or, if desired, compounded into tablet form, with other art-recognised ingredients. The solution of the solid form results in a completely transparent consumable product with a full flavour.

Carriers are well known in the field of spray drying, but not all are suitable for use in connection with this system. It has been found that high MW gum arabic is particularly suitable.

The disclosure therefore further provides a solid-form clear beverage product concentrate, preparable by taking a concentrate as hereinabove described and processing it as hereinabove described.

The process is further described with reference to the following non-limiting examples.

### COMPARATIVE EXAMPLE 1

A nanoemulsion (Comparative Example 1) with a composition given in Table 1 was prepared by blending deionised water, propylene glycol, glycerine and sugar syrup until homogeneous. Quillaja extract was added and the blend was again stirred until homogeneous. Under high shear using a Polytron PT6100 system equipped with a PT-DA 3030-6060 dispersing aggregate the Orange flavour base was added to the water phase. High shear blending was continued at 18000 rpm for 5 minutes. The resulting coarse emulsion was processed through an APV60 high pressure homogeniser at 400/50 bars (5600/700 psi) 3 times. The hydrodynamic diameter was determined on a Zetasizer HSA (Malvern Instruments) using the instrument as per the instructions. Values given are averages of three measurements.

pH of the emulsion: 4.8
hydrodynamic diameter after three homogenisation passes: 134 nm

TABLE 1

| | Comparative Example 1 |
|---|---|
| Ingredient Name | g/kg |
| Deionised water | 27.5 |
| Propylene glycol | 150.0 |
| Glycerine 99.5% | 200.0 |
| Quillaja extract* | 50.0 |
| Sugar syrup 65 Brix | 538.5 |
| Orange flavour base** | 34.0 |

*Q-Naturale ™ 200 (National Starch Food Innovation)
**Product code 96584505 (Givaudan)

### EXAMPLES 1-4

Nanoemulsions were prepared according to the process described for Comparative Example 1 with the only difference that the amount of citric acid given in Table 2 was first dissolved in deionised water before solvents and sugar syrup were added. The amount of acid added is subtracted from the amount of water given in Comparative Example 1. pH values and hydrodynamic diameters are given in Table 2. All hydrodynamic diameters are significantly lower than that in Comparative Example 1 without acid added before homogenisation. The lower the pH, the smaller is the size of the nanoemulsion droplets.

TABLE 2

| | Amount of citric acid added | | Hydrodynamic |
|---|---|---|---|
| Example | (g/kg emulsion) | pH | diameter (nm) |
| 1 | 1.65 | 3.8 | 111 |
| 2 | 4.00 | 3.2 | 109 |
| 3 | 6.34 | 2.9 | 105 |
| 4 | 12.00 | 2.6 | 100 |

### EXAMPLES 5-12

Nanoemulsions were prepared according to the process described for Comparative Example 1 with the only difference that the amount of organic acids given in Table 3 was first dissolved in deionised water before solvents and sugar syrup were added. The amount of acid added is subtracted from the amount of water given in Comparative Example 1. pH values and hydrodynamic diameters are given in Table 3. All hydrodynamic diameters are significantly lower than that in Comparative Example 1 without acid added before homogenisation. The stronger the acid, the smaller the amount of acid needed to achieve a particular pH.

TABLE 3

| | | Amount of acid added | | Hydrodynamic |
|---|---|---|---|---|
| Example | Acid used | (g/kg emulsion) | pH | diameter (nm) |
| 5 | Ascorbic acid | 12.00 | 3.6 | 110 |
| 6 | Tartaric acid | 1.65 | 3.4 | 112 |
| 7 | Tartaric acid | 4.00 | 2.9 | 105 |
| 8 | Tartaric acid | 6.34 | 2.7 | 103 |
| 9 | Malic acid | 1.65 | 3.6 | 119 |
| 10 | Malic acid | 4.00 | 3.2 | 110 |
| 11 | Malic acid | 8.00 | 3.0 | 103 |
| 12 | Malic acid | 12.00 | 2.8 | 100 |

### EXAMPLE 13

A nanoemulsion was prepared according to the process described for Comparative Example 1 with the only difference that the amount of phosphoric acid given in Table 4 was first dissolved in deionised water before solvents and sugar syrup were added. The amount of acid added is subtracted from the amount of water given in Comparative Example 1. pH value and hydrodynamic diameter after three passes of high pressure homogenisation are given in Table 4. The hydrodynamic diameter is significantly lower than that in Comparative Example 1 without acid added before homogenisation.

TABLE 4

| | Amount of acid added | | Hydrodynamic |
|---|---|---|---|
| Example | (g/kg emulsion) | pH | diameter (nm) |
| 13 | 1.5 | 3.0 | 110 |

### COMPARATIVE EXAMPLES 2-3 AND EXAMPLES 14-16

Nanoemulsions comparable to those described above were prepared using a different Orange and a Lemon flavour base. Table 5 displays flavour base, amounts of citric acid added and hydrodynamic diameters after three homogenisaton passes.

TABLE 5

| | | Amount of acid added | Hydrodynamic |
|---|---|---|---|
| Example | Flavour base | (g/kg emulsion) | diameter (nm) |
| CE2 | Orange* | | 142 |
| 14 | Orange* | 3.00 (plus 1.50 sodium | 117 |
| | | benzoate) | |
| 15 | Orange* | 1.65 | 118 |
| CE3 | Lemon** | | 148 |
| 16 | Lemon** | 1.65 | 122 |

*Product Code 96584506 (Givaudan)
**Product Code 96584510 (Givaudan)

### COMPARATIVE EXAMPLE 4 AND EXAMPLE 17 (SAME AS EXAMPLE 1)

A nanoemulsion (Comparative Example 4) was prepared according to the process described for Comparative Example 1. However, amounts of water, solvents and quillaja extract were changed to allow dissolution of an additional emulsifier (gum arabic) in the water phase before homogenisation. The ratio of quillaja extract and gum arabic was chosen according to examples disclosed in EP 2359702 to show that the combination with an emulsifying polymer as in EP 2359702 does not work to achieve sufficiently low diameters. For comparison, the compositions of Comparative Example 4 and Example 1 are given in Table 6 together with hydrodynamic diameters measured after one, two and three passes through a high pressure homogeniser. The combination of quillaja extract and gum arabic results in significantly larger droplet diameters than in Comparative Example 1 (without acid) and in Example 1 (with acid) even in the presence of citric acid. It was further found that after two passes of high pressure homogenization the hydrodynamic diameter is not further reduced.

TABLE 6

| | Comparative | Example 1 |
|---|---|---|
| Ingredient Name | Example 4 (g/kg) | (g/kg) |
| Deionised water | 55.20 | 25.85 |
| Citric acid | 1.65 | 1.65 |
| Gum Arabic* | 36.80 | |
| Propylene glycol | 100.00 | 150.00 |
| Glycerine 99.5% | 193.85 | 200.00 |
| Quillaja extract** | 40.00 | 50.00 |
| Sugar syrup 65 Brix | 538.50 | 538.50 |
| Orange flavour base*** | 34.00 | 34.00 |

Hydrodynamic diameter (nm)

| | | |
|---|---|---|
| After 1 pass | 184 | 147 |
| After 2 passes | 163 | 119 |
| After 3 passes | 170 | 111 |

*Gum Arabic Instant AA (CNI)
**Q-Naturale ™ 200 (National Starch Food Innovation)
***Product Code 96584505 (Givaudan)

1. A clear beverage concentrate comprising:
a nanoemulsion of a liquid flavor oil in an aqueous phase in the presence of an emulsifier,
wherein the pH of the aqueous phase is 4.0 maximum,
wherein the emulsifier is at least 5% by weight quillaja saponins,
wherein the weight ratio of the quillaja saponins to the liquid flavor oil is about 0.1 to about 3.0, and
optionally containing up to 95% by weight of total emulsifier of at least one other emulsifier,
wherein the concentrate provides a beverage having a turbidity of less than 10 NTU.

2. The clear beverage concentrate of claim 1, wherein the proportion of quillaja saponins in the emulsifier is 25% by weight.

3. The clear beverage concentrate of claim 1, wherein the proportion of quillaja saponins in the emulsifier is 50% by weight.

4. The clear beverage concentrate of claim 1, wherein the proportion of quillaja saponins in the emulsifier is 75% by weight.

5. The clear beverage concentrate of claim 1, wherein the proportion of quillaja saponins in the emulsifier is 100% by weight.

6. The clear beverage concentrate of claim 1, wherein the at least one other emulsifier is selected from the group consisting of polysorbates, sucrose esters esters of fatty acids, polyglycerol esters of fatty acids, lecithin, and combinations thereof.

7. The clear beverage concentrate of claim 1, wherein the flavor oil comprises lemon oil or orange oil.

8. The clear beverage concentrate of claim 1, further comprising at least one monosaccharide or disaccharide at a concentration of from 10-50 wt. % of the nanoemulsion.

9. The clear beverage concentrate of claim 8, wherein the at least one monosaccharide is selected from glucose and fructose.

10. The clear beverage concentrate of claim 8, wherein the at least one disaccharide is sucrose.

11. The clear beverage of claim 10, further comprises a beverage solvent selected from the group consisting of propylene glycol, glycerol, and combinations thereof, wherein the beverage solvent is present at a concentration of from 10-95% of the nanoemulsion.

12. The clear beverage of claim 11, wherein the beverage solvent comprises s combination of propylene glycol and glycerol at a concentration of from 10-25% of the nanoemulsion.

13. The clear beverage of claim 11, wherein the beverage solvent comprises s combination of propylene glycol, glycerol and sucrose at a concentration 10-40 wt. % of propylene glycol, 24-25 wt. % glycerol and 27-35 wt. % sucrose of the nanoemulsion.

14. The clear beverage concentrate of claim 1, further comprising a food approved acid selected from the group consisting of citric acid, malic acid, acetic acid, lactic acid, ascorbic acid, tartaric acid, phosphoric acid, and combinations thereof.

15. The clear beverage concentrate of claim 14, wherein the food approved acid comprises citric acid.

16. The clear beverage concentrate of claim 1, further comprising a preservative.

17. A clear beverage concentrate comprising:
a nanoemulsion of a liquid flavor oil in an aqueous phase in the presence of an emulsifier,
wherein the pH of the aqueous phase is 4.0 maximum,
wherein the emulsifier is at least 5% by weight quillaja saponins,
wherein the weight ratio of the quillaja saponins to the liquid flavor oil is about 0.1 to about 3.0,
wherein the nanoemulsion comprises particles with a hydrodynamic diameter in the range of 100 nm to 122 nm, and
optionally containing up to 95% by weight of total emulsifier of at least one other emulsifier.

18. A solid-form clear beverage concentrate comprising:
a nanoemulsion of a liquid flavor oil in an aqueous phase in the presence of an emulsifier,
wherein the pH of the aqueous phase is 4.0 maximum,
wherein the emulsifier is at least 5% by weight quillaja saponins,
wherein the weight ratio of the quillaja saponins to the liquid flavor oil is about 0.1 to about 3.0,
at least one monosaccharide or disaccharide at a concentration of from 10-50 wt. % of the nanoemulsion,
optionally containing up to 95% by weight of total emulsifier of at least one other emulsifier; and
a carrier comprising gum Arabic having a molecular weight greater than 100 KDa.

19. A clear beverage comprising:
water or a clear beverage base and the concentrate of claim 1, wherein the beverage has a turbidity of less than 10 NTU.

20. A clear beverage comprising:
water or a clear beverage base and the concentrate of claim 17, wherein the beverage has a turbidity of less than 10 NTU.

21. A clear beverage comprising:
water or a clear beverage base and the concentrate of claim 18, wherein the beverage has a turbidity of less than 10 NTU.
